(19) United States
(12) Patent Application Publication
(10) Pub. No.: US 2025/0065933 A1
(43) Pub. Date: Feb. 27, 2025

(54) MILITARY GRADE TELESCOPING BACKPACK EXTRACTION CART

(71) Applicant: John Jablonski, Ravenna, OH (US)

(72) Inventor: John Jablonski, Ravenna, OH (US)

(21) Appl. No.: 18/939,896

(22) Filed: Nov. 7, 2024

Related U.S. Application Data
(63) Continuation-in-part of application No. 18/068,001, filed on Dec. 19, 2022.

(51) Int. Cl. B62B 1/20; B62B 1/12; B62B 5/06

(52) U.S. Cl. CPC B62B 1/208; B62B 1/125; B62B 5/068

(57) ABSTRACT

A self-contained portable material transport cart for game transport and utility transport of equipment and supplies including emergency medical transport in multiple venues. The extraction cart has a lightweight collapsible frame with cargo support straps or netting. Fixed and folding wheels and telescopically extensible frame members allow for compact storage and backpack transport to user location. Extensible frame is adjustable for length and width for cargo transport with an optional trailer hitch adapter allowing the cart to be pulled by an off-road vehicle, if needed.

This application is a Continuation in Part of Ser. No. 18/068,001, filed Dec. 19, 2022.

### BACKGROUND OF THE INVENTION

### 1. Technical Field

This invention relates to portable wheeled carts and the like that function as cargo sleds to transport loads over uneven and difficult terrain.

### 2. Description of Prior Art

Prior art devices of this type have been developed for wheeled transport, see for example U.S. Pat. Nos. 2,629,608, 6,217,043 and U.S. Publications 2004/0130112, 2017/0135332 and 2007/025255.

In U.S. Pat. No. 2,629,608 an animal carrying cart is disclosed having a V-shaped frame with a single end wheel in oppositely disposed wide frame extending handle portions for engagement.

U.S. Pat. No. 6,217,043 claims a portable cart and method having a compact tubular frame construction with a pair of wheels and a material netting in a rectangular configuration.

U.S. Publication 2004/013112 is a one-wheeled collapsible deer drag with a fixed

V-shaped tubular frame with user engagement straps extending therefrom.

U.S. Publication 2017/0135332 illustrates a collapsible one-wheeled game cart with carrying straps.

Finally, in U.S. Publication 2007/025255 a combination hunting stand and cart is disclosed having a ladder frame defining a hunting station and a one-wheeled cart to transport game from the woods.

### SUMMARY OF THE INVENTION

A portable collapsible two wheeled transport cart with tubular telescoping lightweight frame elements that provide longitudinal adjustment extensions. A pair of fixed and folding wheels for ground engagement or folded for cart transport. Cross and elongated netting is provided for game and material transport providing a multiple use universal wheeled cart for a variety of uses. The cart can be collapsed and carried on a backpack configuration and may have interchangeable wheels size for varied terrain accessibility. An optional travel hitch is provided for powered towed transport.

### DESCRIPTION OF THE DRAWINGS

FIG. 1 is a perspective view of the transport sled of the invention in open use position.

FIG. 2 is a side elevational view thereof.

FIG. 3 is a top plan view of the transport sled.

FIG. 4 is a top plan view of the transport cart in collapsed transport position.

FIG. 5 is an enlarged partial end elevational view of the cart's fixed wheel and mounting.

FIG. 6 is a side elevational view of the transport cart shown in use with a person.

FIG. 7 is an enlarged partial top plan view of the trailer hitch option for the transport cart.

FIG. 8 is a side elevational view of the transport sled of the invention with trailer hitch and an ATV shown in broken lines.

FIG. 9 is a perspective view of the transport sled in collapsed transport position as a backpack configuration on a user.

FIG. 10 is a partial side elevational view of an alternate folding support wheel assembly in solid lines and in folded position in broken lines.

FIG. 11 is a partial front sectional view thereof with wheel assembly in folded position in broken lines.

FIG. 12 is a perspective view of the alternate form of the invention.

FIG. 13 is a top plan view thereof.

FIG. 14 is a side elevational view thereof.

FIG. 15 is a side elevational view of the alternate transport cart in use with a person.

FIG. 16 is a reverse or rear side elevational view of the alternate transport cart in collapsed position.

FIG. 17 is a front elevational view on lines 17-17 of FIG. 16.

FIG. 18 is a top plan view thereof.

FIG. 19 is a side elevational view of the alternate transport cart of the invention with a hitch for towing by a powered vehicle illustrated in broken lines.

FIG. 20 is a top plan view of the transport cart illustrating the convertible trailer hitch.

FIG. 21 is a bottom plan view of the transport cart in collapsed configuration mounted vertically on a backpack of a user for transport.

FIG. 22 is a side elevational view thereof on a person for transport.

FIG. 23 is a side elevational view of the transport cart equipped with ski runners.

FIG. 24 is an end elevational view thereof.

### DETAILED DESCRIPTION OF THE INVENTION

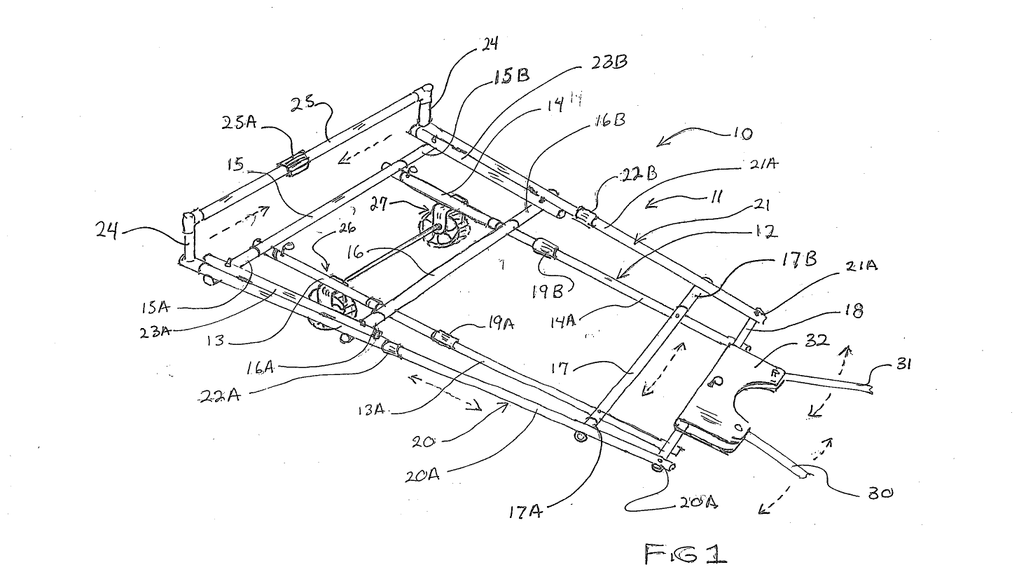

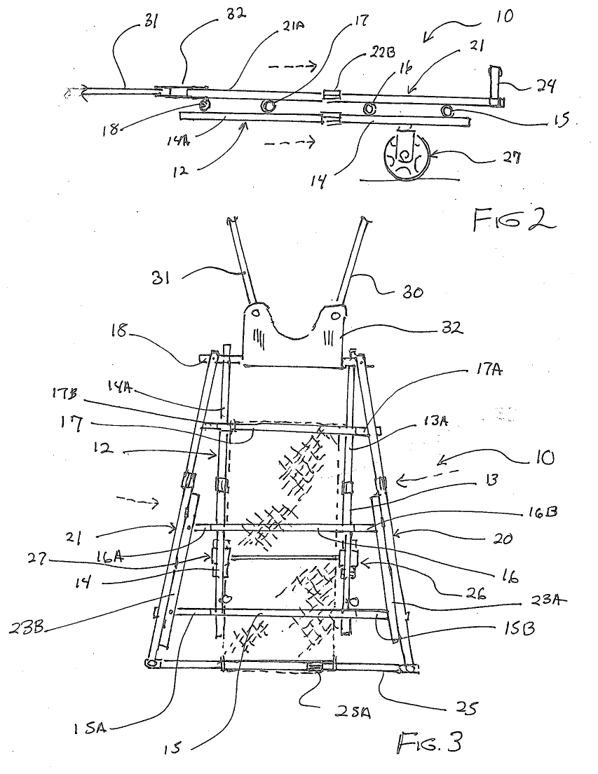

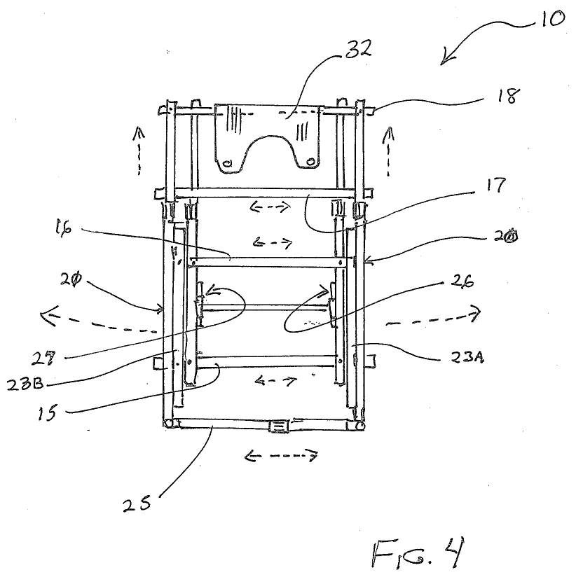

Referring now to FIGS. 1-3 of the drawings a wheeled transport cart 10 of the invention can be seen having a tubular frame 11 with a primary rectangular support portion 12. A pair of spaced parallel rails 13 and 14 are secured together by spaced parallel transverse elements 15, 16 and 17 with a front cross member 18. The rails 13 and 14 have adjustable telescopically extensible portions 13A and 14A with respective frame member extension locks 19A and 19B. The transverse connection frame elements 15, 16 and 17 each have adjustable extensible telescopic end portions 15A, 15B, 16A, 16B and 17A and 17B which are pivotally secured at right angles to a secondary pair of spaced tubular rails 20 and 21. The secondary rails 20 and 21 in spaced parallel relation to the primary rails 13 and 14 each have a telescopically extensible portions 20A and 21A with corresponding adjustable tubular frame locks 22A and 22B which allow for locking frictional engagement of the respective telescopically extensible portions. A pair of reinforcement tubular elements 23A and 23B are secured to the secondary rails extending over the corresponding cross members 15 and 16. The respective ends of the secondary rails 20, 20A and 21, 21A are pivotally secured to the hereinbefore described respective front cross end element 15 and oppositely disposed cross element 18.

A pair of upstanding tubular elements 24 and fittings extend from the secondary rails 20 and 21 oppositely disposed ends with a rear cross connection member 25 pivotally secured there between. The rear cross member 25 has a telescopic frame lock 25A for transverse extension. The multiple rail construction forms the compound adjustable transport frame 11 that will be described in use hereinafter.

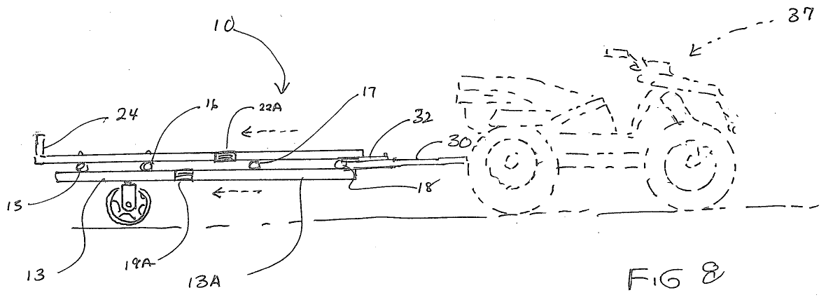

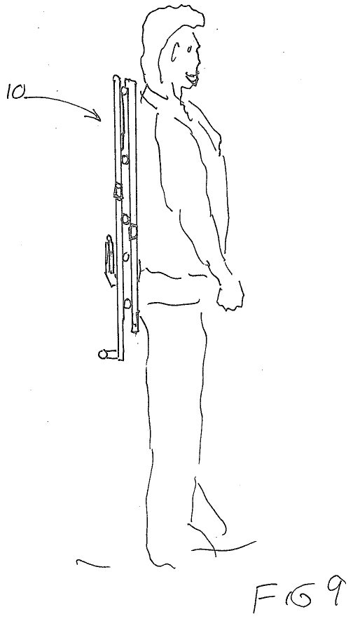

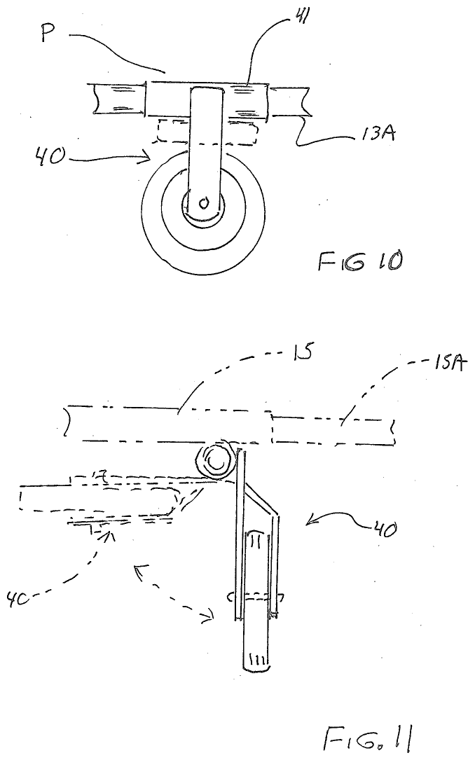

It will be seen that a pair of fixed wheel assemblies 26 and 27 are positioned on the primary side rails 13 and 14 between the cross-frame elements 15 and 16, each having a rail engagement with depending apertured brackets 29 for wheel and axle assemblies 29A respectively. An alternate folding wheel assembly 40 can be seen in FIGS. 10, and 11 of the drawings. Rail engagement sleeves 41 are secured with a pin P extending through aligned openings in their respective side rail 13 and 14 ends. This orientation allows each of the wheel assemblies 40 to be locked in either a ground engagement position or selectively rotated and secured in a transport position shown in broken lines in FIGS. 10 and 11 of the drawings. It will be noted that interchangeable, wide wheels (not shown) can used for sand transport.

The compound adjustable transport frame 11 will therefore provide an expandable triangular support structure as seen being deployed in FIGS. 1, 2 and 3 of the drawings tapering from the extended rear cross frame member 25 to the front-end cross element 18. A pair of user engagement handle extensions 30 and 31 are rotatably secured within a mounting housing 32 positioned over the cross element 18 to provide adjustability orientation of the handles 30 and 31 so as to accommodate a wide variety of users U as best seen in FIG. 6 of the drawings, thereby allowing the user U to grip and pull the transport cart 10 along behind him as is well known within the art.

It will be seen that a flexible mesh net transport support panel fitting 33 is selectively secured to the respective rail and cross frame members to provide cross support for materials M or game engagement on the cart or human extraction, not shown.

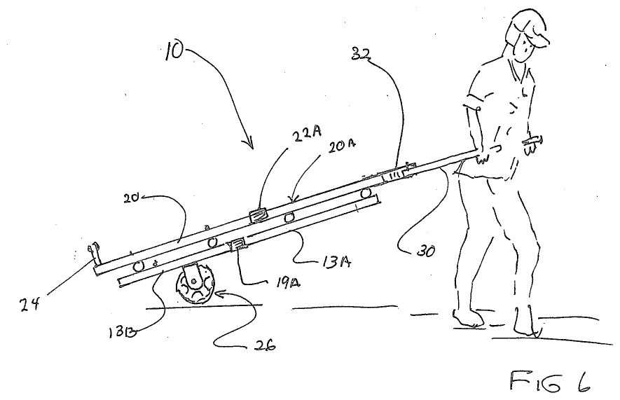

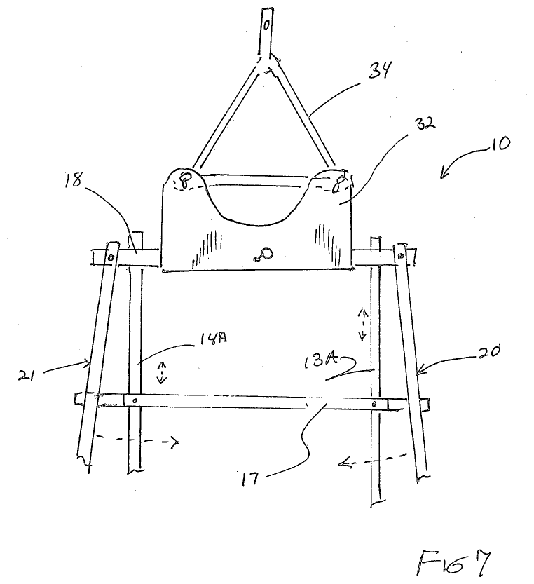

Referring now to FIGS. 7 and 8 of the drawings, a tubular trailer hitch fitting 34 can be seen selectively secured within the end frame engagement mounting bracket 32. The bracket 32 is positioned on the front-end cross member 17 with mounting apertures.

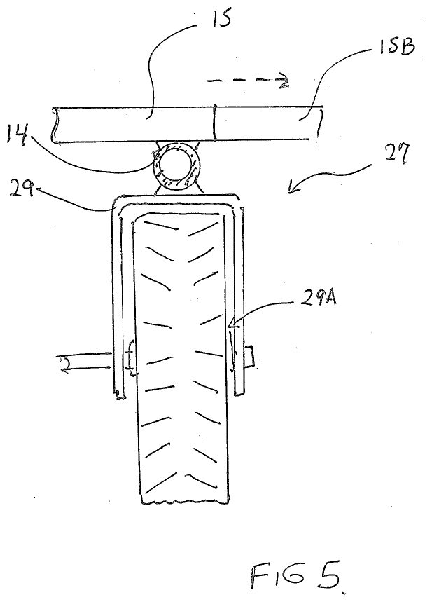

The apertured trailer hitch fitting 34 will allow the transport cart 10 to be towed by a powered vehicle such as an off-road ATV 37 shown in broken lines in FIG. 10 of the drawings. It will be evident from the above description that the new and novel transport cart 10 will provide a self-contained universal transport capable of being adjustably collapsed into itself into a compact easily transportable configuration as illustrated in FIG. 5 of the drawings by telescopically adjustable rails 13 and 14 and 20 and 21 with transversely adjustable of the multiple frame elements 15, 16, and 17 and rear cross member 25. The size and the lightweight military grade construction, in this example of tubular aluminum elements allows for easy transport that can be carried in a backpack configuration as seen in FIG. 11 of the drawings, for example. As noted, the frame 11 is preferably formed from lightweight tubular aluminum with multiple pivotal engagement points and slidably extensible telescopically interengagement frame elements locked in place by corresponding friction lock fittings.

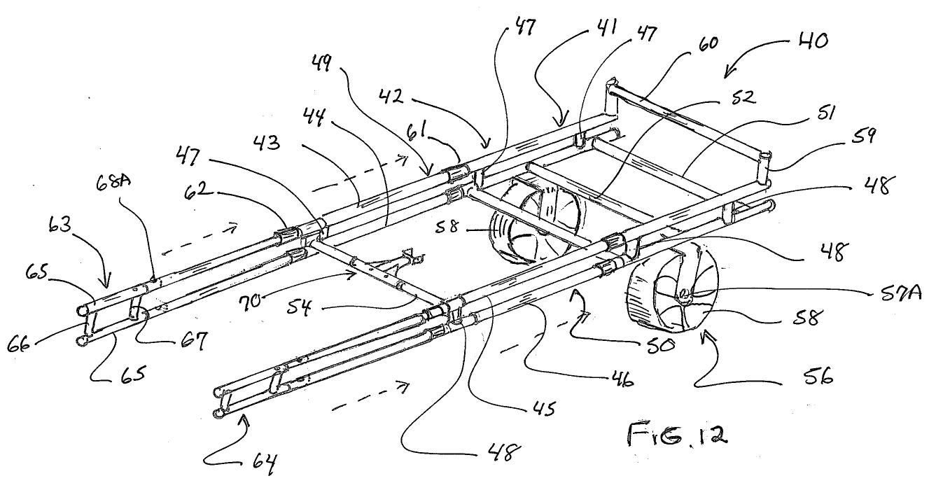

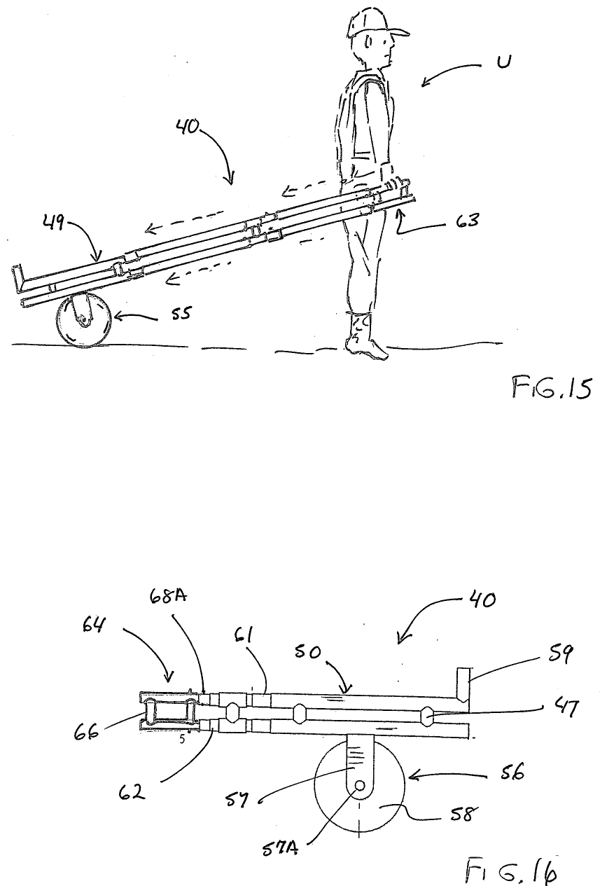

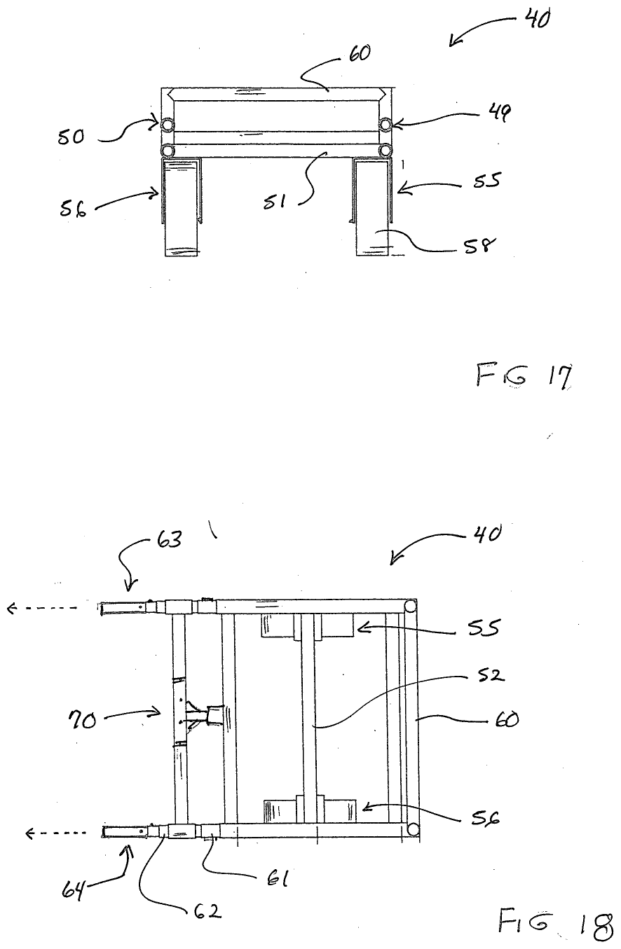

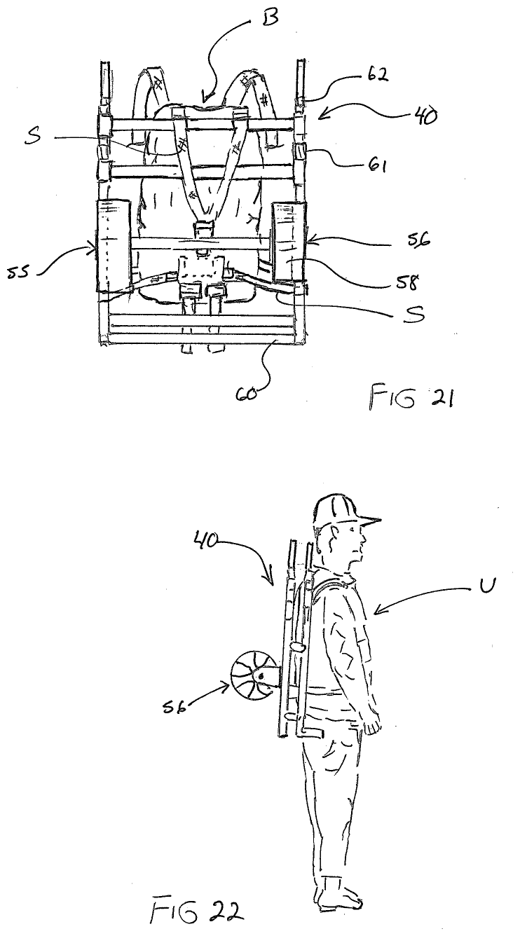

Referring now to FIGS. 12-22 of the drawings, an alternate form of the wheeled transport cart 40 can be seen having a modified tubular frame 41 of a rectangular support portion 42. Pairs of vertically spaced parallel rails 43 and 44 and 45 and 46 are secured independently together by upstanding connector elements 47 and 48 respectively therebetween defining side rail assemblies 49 and 50.

The side rail assemblies 49 and 50 are secured in spaced parallel relation to one another by fixed transverse connecting tubular frame elements 51, 52, 53 and 54 defining a rectangular transport frame of the invention.

A pair of fixed wheel assemblies 55 and 56 are secured to the corresponding connecting element 52 and has apertured depending support brackets 57 with wheel support axles 57A for respective wheels 58, as best seen in FIGS. 1-3 and 6 of the drawings.

A pair of upstanding tubular support elements 59 extend from the ends of the respective rails 43 and 44 with a cross-connecting member 60 secured therebetween. Each of the respective spaced parallel rail pairs 43 and 44 and 45 and 46 are telescopically enabled for the longitudinal adjustment of each of the rail pairs enabled by multiple locking friction fittings 61 and 62 as best seen in FIGS. 1 and 3 of the drawings and directional orientation indicated by broken line directional arrows for expansion or contraction, as needed.

A pair of handle assemblies 63 and 64 are selectively secured telescopically within the free ends of the side rail assemblies 49 and 50, each handle assembly having spaced upper and lower parallel members 65 interconnected by a fixed end cross support 66 and interconnecting sleeve and bolt fittings 67 respectively.

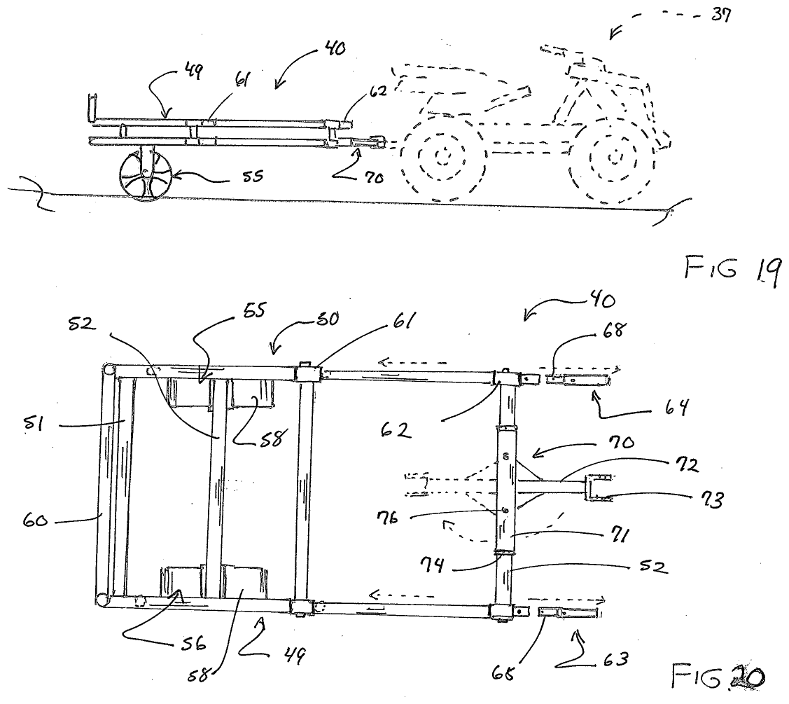

Insertion end portions 68 of the handles are of a reduced diameter as best seen in FIGS. 20 and 21 of the drawings with an attachment bolt assembly 68A through aligned apertures in both the insertion portion 68 and the respective free ends of the side rail assemblies 49 and 50.

The handle assemblies 63 and 64 provide for user engagement in ground transport configuration as seen in FIG. 15 of the drawings.

A convertible hitch fitting 70 is provided, best seen in FIGS. 12, 19 and 20 of the drawings, having a rotatable sleeve element 71 secured over the center portion of the cross member 59 with a right-angle extension 72 onto which a trailer hitch 73 is secured on its free end.

A pair of oppositely disposed locking collars 74 having registration pins 75 extending there through are secured on the cross member 59 centering the hitch fitting 70's rotatable sleeve element 71. The sleeve 71 allow for the hitch fitting 70 to be rotated 180 degrees when not in use as illustrated in broken lines in FIG. 20 of the drawings and secured in respective positions by sleeve pins 76 in registration aligned apertures in the cross member 59 as will be understood by those in the art.

Referring now to FIG. 13 of the drawings, a flexible mesh net transport support panel 77 can be seen selectively secured to the respective side rail assemblies 49 and 50 and to provide cross support surfaces for materials positioned thereon, not shown.

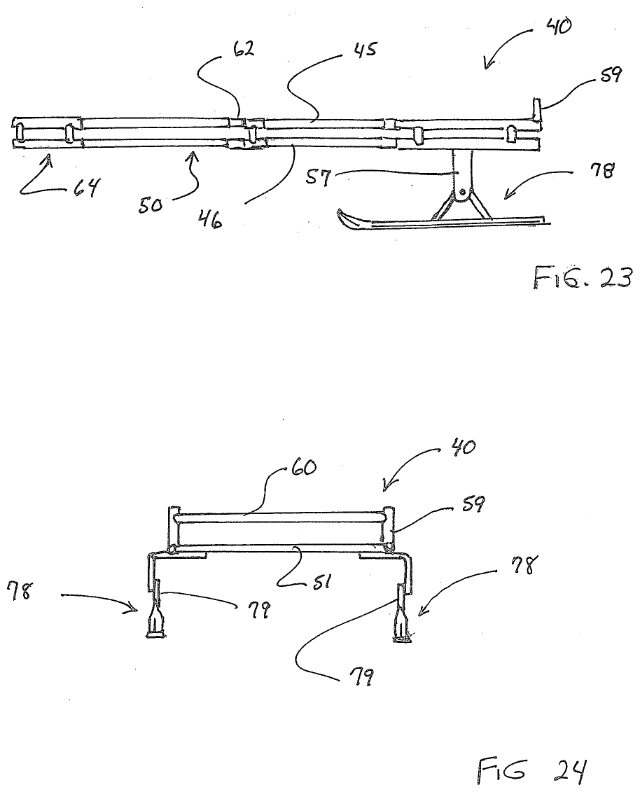

Referring now to FIGS. 23 and 24 of the drawings, an alternate transport configuration is illustrated wherein a pair of ski runners 78 replace the original wheel assemblies 55 and 56 respectively supported by corresponding tubular elements 79 secured to the wheel support brackets 57 as hereinbefore described.

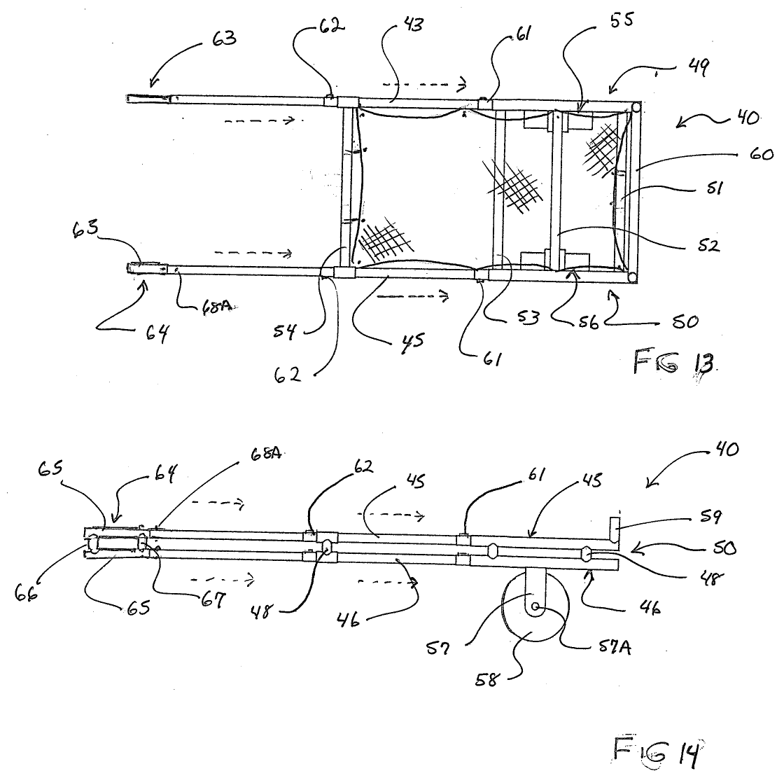

It will be evident from the above description that the alternate wheel transport cart 40 of the invention can therefore be longitudinally collapsed to a transport configuration as seen in FIGS. 16, 17 and 18. The collapsed wheel transport cart 40 can be secured to a user's U backpack B by straps S allowing for ease of transport and then removed and deployed when needed. It will be seen that as the preferred embodiment the respective frame members are preferably formed from thin lightweight tubular aluminum with the multiple locking fittings 59 and 60 allowing for both extension during use and collapsing transport configuration, as noted.

It therefore will be evident to those skilled in the art that various changes and modifications may be made thereto without departing from the spirit of the invention.

Therefore I claim:

1. A collapsible portable transport cart used in hunting and material transport comprising, a pair of longitudinally extending tubular frame side rail assemblies in spaced parallel relation to one another, multiple transversely connecting frame elements secured in longitudinal spaced relation between said frame rail assemblies, each of said side rail assemblies comprising,
a pair of vertically spaced telescopically extensible parallel rails interconnected vertically by upstanding connector elements there between,
said side rail assemblies are telescopically extensible from a first collapsed transport position to an extended open use portion,
fixed wheel assemblies attached respectively to one of said transversely connecting frame elements,
an upstanding rear cross connecting member in offset parallel spaced relation to one of said connecting frame elements,
tubular frame locks on respective vertically spaced telescopically extensible parallel rails assemblies interconnecting said respective rails,
handle assemblies selectively secured to respective open free ends of said respective frame rail assemblies,
a convertible hitch assembly on one of said cross members rotatable from a first engagement position to a second storage portion.

2. The collapsible portable transport cart set forth in claim 1 wherein a flexible mesh material transport panel is secured between said respective side rail assemblies and connecting frame elements in spaced relation to one another.

3. The collapsible portable transport cart set forth in claim 1 wherein said handle comprises, vertically spaced interconnected parallel members, telescopically received in open free ends of said respective tubular frame rail assemblies.

4. The collapsible portable transport cart set forth in claim 1 wherein said convertible hitch assembly comprises, a sleeve and pair of locking collars selectively secured to said one of said transversely connecting frame elements, an angular extension on said sleeve and a hitch thereon.

5. The collapsible portable transport cart set forth in claim 1 wherein said first collapsed transport position is selectively secured to a backpack configuration having extending frame rail assemblies engagement straps extend therefrom.

6. The collapsible portable transport cart set forth in claim 1 wherein said fixed wheel assemblies have interchangeable ski runners in place of wheels.
